(19) United States
(12) Patent Application Publication
(10) Pub. No.: US 2019/0092900 A1
(43) Pub. Date: Mar. 28, 2019

(54) METHOD FOR PREPARING POLYBUTYLENE TEREPHTHALATE

(71) Applicant: LG CHEM, LTD., Seoul (KR)

(72) Inventors: Suk Yung OH, Daejeon (KR); Soo Hwan HWANG, Daejeon (KR); Jeong Seok LEE, Daejeon (KR); Mi Kyung KIM, Daejeon (KR)

(73) Assignee: LG CHEM, LTD., Seoul (KR)

(21) Appl. No.: 16/086,286

(22) PCT Filed: Oct. 19, 2017
(86) PCT No.: PCT/KR2017/011614

§ 371 Date: Sep. 18, 2018

(30) Foreign Application Priority Data
Oct. 20, 2016 (KR) 10-2016-0136733

(51) Int. Cl. C08G 63/183; C08G 63/78

(52) U.S. Cl. CPC C08G 63/183; C08G 63/78

(57) ABSTRACT

The present disclosure relates to a method for preparing polybutylene terephthalate, and the method for preparing polybutylene terephthalate of the present disclosure recycles the recovered 1,4-butanediol, so the condensation efficiency in the condenser is not lowered. Therefore, the degree of vacuum of the polycondensation reactor is maintained, so that the preparation efficiency and the degree of polymerization of polybutylene terephthalate can be increased.

### TECHNICAL FIELD

### CROSS-REFERENCE TO RELATED APPLICATION

This application claims the benefits of Korean Patent Application No. 10-2016-0136733 filed on Oct. 20, 2016 with the Korean Intellectual Property Office, the disclosure of which is incorporated herein by reference in its entirety.

The present disclosure relates to a method for preparing polybutylene terephthalate, and specifically to a method for operating a condenser in a process for preparing polybutylene terephthalate.1

### BACKGROUND OF ART

Polybutylene terephthalate (PBT) is a resin which is applied to various fields such as electronic parts, mechanical parts, and automobiles because of its excellent mechanical properties, electrical characteristics and heat resistance.

A DMT method is one of the most widely used methods for preparing polybutylene terephthalate. The DMT method is largely divided into two steps. First, dimethyl terephthalate and 1,4-butanediol are reacted in the presence of a transesterification catalyst to prepare a polybutylene terephthalate oligomer, and then polycondensation reaction of the polybutylene terephthalate oligomer is proceeded. The DMT method is a batch process and is currently applied to industrial mass production methods.

Since the polycondensation reaction is a reversible reaction, 1,4-butanediol, which is a product of the polycondensation, should be removed by volatilization to prepare polybutylene terephthalate having a high molecular weight. As 1,4-butanediol is a compound with a high boiling point (boiling point: about 235° C.), in order to volatilize the 1,4-butanediol, the polycondensation reaction is usually carried out in high vacuum and the volatilized 1,4-butanediol should be condensed.

The volatilized 1,4-butanediol is recovered to an upper part of the polycondensation reactor, and then condensed by a condenser and removed. At this time, since low boiling point substances (water, methanol, tetrahydrofuran, etc.) are also volatilized in addition to 1,4-butanediol, the total boiling point of the volatile substances recovered to the upper part of the polycondensation reactor becomes low. As the boiling point becomes low, temperature difference from a refrigerant of the condenser becomes smaller, resulting in the following problems.

First, partial volatilization of the volatile substances occurs, and then decompression of the polycondensation reactor is delayed. In addition, the condenser tube becomes dry, thereby worsening plugging of the entrained polybutylene terephthalate oligomer with the volatile substances. Further, in high vacuum, uncompensated residual gases move to a vacuum system to cause plugging in a pipeline or vacuum pump, thereby lowering the degree of vacuum and shortening the cleaning and replacement cycle of various facilities.

In order to increase the temperature difference between the refrigerant of the condenser and the volatile gas, a method of lowering the temperature of the refrigerant can be considered. However, since the freezing point of 1,4-butanediol is about 20° C., there is a limit in lowering the temperature of the refrigerant.

Accordingly, the present inventors have made intensive studies on a method of not lowering the efficiency of the condenser in the process for preparing polybutylene terephthalate. And then, they confirmed that the efficiency of the condenser is not lowered when the recovered 1,4-butanediol is recycled to the condenser as described later, completing the present invention.

### DETAILED DESCRIPTION OF THE INVENTION

### Technical Problem

The present disclosure is to provide a method for preparing polybutylene terephthalate in which efficiency of a condenser is not decreased.

### Technical Solution

In order to solve the above problems, the present disclosure provides a method for preparing polybutylene terephthalate, including the steps of:

1) feeding a polybutylene terephthalate oligomer prepared by reacting dimethyl terephthalate and 1,4-butanediol in the presence of a transesterification catalyst to a polycondensation reactor;

2) proceeding polycondensation reaction of the polybutylene terephthalate oligomer fed to the polycondensation reactor, and then feeding volatile substances recovered to an upper part of the polycondensation reactor to a condenser, and recovering polybutylene terephthalate to a lower part of the polycondensation reactor;

3) condensing the volatile substances fed to the condenser, and then feeding it to a separator;

4) separating 1,4-butanediol from the condensed volatile substances fed to the separator, and then feeding it to a 1,4-butanediol tank; and

5) feeding 1,4-butanediol fed to the 1,4-butanediol tank to the condenser.

The present disclosure relates to a DMT method, which is one of the preparation methods of polybutylene terephthalate. First, dimethyl terephthalate and 1,4-butanediol are reacted in the presence of a transesterification catalyst to prepare a polybutylene terephthalate oligomer, and then polycondensation reaction of the polybutylene terephthalate oligomer is proceeded.

In particular, the present disclosure is intended to prevent the boiling point of the volatile substances recovered to the upper part of the polycondensation reactor from lowering. In order to achieve this object, the present disclosure is characterized in that a part of the recovered 1,4-butanediol is circulated to the condenser.

Hereinafter, the present disclosure will be described in detail in each step. In addition, drawings are also referred to for better explanation.

(Step 1) A step of feeding a polybutylene terephthalate oligomer prepared by reacting dimethyl terephthalate and 1,4-butanediol in the presence of a transesterification catalyst to a polycondensation reactor (100)

The step 1 is a step of preparing polycondensation reaction of a polybutylene terephthalate oligomer by feeding a polybutylene terephthalate oligomer to a polycondensation reactor (100).

The transesterification catalyst is not particularly limited as long as it can be used for the reaction of dimethyl terephthalate and 1,4-butanediol. For example, organic titanium, organic tin, organic zirconia, and the like may be used, and specifically, tetrabutyl titanate may be used. The transesterification catalyst is preferably used in an amount of 0.1 to 10 mol based on 1000 mol of dimethyl terephthalate.

In addition, a molar ratio of the dimethyl terephthalate to the 1,4-butanediol is preferably 1:1 to 1:3, and particularly, 1,4-butanediol is preferably used in excess of the molar amount of dimethyl terephthalate. More preferably, the molar ratio of the dimethyl terephthalate to the 1,4-butanediol is 1:1.2 to 1:1.5.

The reaction is preferably carried out under a pressure of 0.5 to 2 bar, more preferably at atmospheric pressure (1 bar). And, the reaction is preferably carried out at 100° C. to 200° C. More preferably, the reaction proceeds while raising the reaction temperature. Further, the reaction is preferably carried out for 10 minutes to 10 hours.

By the above reaction, a polybutylene terephthalate oligomer is prepared by the transesterification of dimethyl terephthalate and 1,4-butanediol, which is a prepolymer having a degree of polymerization of about 4 to 10. In addition, methanol is generated by the transesterification, and tetrahydrofuran (THF) and water are generated from 1,4-butanediol as a side reaction. As will be described later, methanol, THF, and water correspond to low boiling point substances.

The prepared polybutylene terephthalate oligomer is fed to the polycondensation reactor (100) through a feeding line (101). Here, low boiling point substances such as methanol, THF, and the like, are also fed thereto in addition to the polybutylene terephthalate oligomer.

(Step 2) A step of proceeding polycondensation reaction of the polybutylene terephthalate oligomer fed to the polycondensation reactor (100), and then feeding volatile substances recovered to an upper part of the polycondensation reactor (100) to a condenser (200), and recovering polybutylene terephthalate to a lower part of the polycondensation reactor (100)

The step 2 is a step of proceeding polycondensation reaction of the polybutylene terephthalate oligomer.

The polycondensation reaction is preferably carried out at 180° C. to 270° C., more preferably at 190° C. to 250° C. And, the polycondensation reaction is preferably carried out for 60 minutes to 240 minutes. If the temperature and time are higher than the above-mentioned temperature and time, volatile organic compounds (VOC) may increase, or carbonization of reactants or discoloration of products may occur due to the increase in the side reaction of the polycondensation reaction.

In addition, the polycondensation reaction is carried out in high vacuum condition. Preferably, the polycondensation reaction is carried out under a pressure of 1 mbar to 50 mbar. To do this, it is preferable to perform the polycondensation reaction while slowly lowering the pressure of the polycondensation reactor (100), immediately after the polybutylene terephthalate oligomer is fed to the polycondensation reactor (100). For example, it is preferable that the reaction is carried out while lowering the pressure of the polycondensation reactor (100) from atmospheric pressure to 1 mbar to 50 mbar. For example, it is preferable to lower the pressure from atmospheric pressure to about 20 mbar for about 50 minutes.

In the process of lowering the pressure as described above, volatilization of the low boiling point substances fed together with the polybutylene terephthalate oligomer mainly proceeds, because the polycondensation reaction has not started. When the pressure reaches high vacuum, the polycondensation reaction of the polybutylene terephthalate oligomer proceeds and 1,4-butanediol is produced in this process. Therefore, there arises a period in which volatilization amount of 1,4-butanediol sharply increases at the time when the polycondensation proceeds. As the polycondensation reaction proceeds, the volatilization amount of 1,4-butanediol gradually decreases, while the low boiling point substances are continuously generated by the transesterification and decomposition reaction.

During the polycondensation reaction, the volatile substances are recovered from the upper part of the polycondensation reactor (100) to the condenser (200) through a line (102). The polycondensation reactor (100), the condenser (200), a separator (300) and a vacuum system (500) are connected through lines (102, 201 and 302), and recovery proceeds through a vacuum pump of the vacuum system (500).

In addition, when the polycondensation reaction is completed, polybutylene terephthalate is recovered from the lower part of the polycondensation reactor (100) through the line (103).

(Step 3) A step of condensing the volatile substances fed to the condenser (200), and then feeding it to a separator (300)

In the step 3, the volatile substances fed to the condenser (200) are condensed to change into liquids.

It is preferable that water (cooling water) is used as a refrigerant for the condensation. Also, the temperature of the refrigerant is preferably 20° C. to 40° C. Since the freezing point of 1,4-butanediol contained in the volatile substances is about 20° C., when the temperature of the refrigerant is lower than 20° C., channels may be clogged due to crystallization or the like. In addition, although the boiling point of the volatile substances varies depending on the reaction time, it is preferably at least about 50° C., and therefore, the temperature of the refrigerant is preferably 40° C. or less.

Also, in order to increase the efficiency of the condensation, the condenser (200) includes a tube-shaped pipe through which volatile substances pass, and makes the length of the pipe as long as possible to increase the area contacting with the refrigerant.

As the volatile substances pass through the condenser (200), the condensation proceeds, and then the volatile substances are changed into a liquid form, and fed to the separator (300) through a line (201). As described above, the polycondensation reactor (100), the condenser (200), the separator (300) and the vacuum system (500) are connected through the lines (102, 201 and 302), and the substances are fed from the condenser (200) to the separator (300) through the vacuum pump of the vacuum system (500).

(Step 4) A step of separating 1,4-butanediol from the condensed volatile substances fed to the separator (300), and then feeding it to a 1,4-butanediol tank (400)

The step 4 is a step of separating 1,4-butanediol from the condensed volatile substances fed to the separator (300).

The separation method is not particularly limited, and for example, a flash drum or a distillation column may be used. In this case, 1,4-butanediol and the low boiling point substances can be separated into a lower part and an upper part, respectively. More preferably, a multi-stage distillation column is used for the separation.

The separator (300) is connected to the vacuum system (500) through the line (302). The separated 1,4-butanediol is fed to the 1,4-butanediol tank (400) through the line (301), and the residual substances are fed to the vacuum system (500).

(Step 5) A step of feeding 1,4-butanediol fed to the 1,4-butanediol tank (400) to the condenser (200)

In the step 5, 1,4-butanediol fed to the 1,4-butanediol tank (400) is fed to the condenser (200) to recycle 1,4-butanediol to the volatile substances recovered from the polycondensation reactor (100). That is, 1,4-butanediol fed to the 1,4-butanediol tank is fed to the condenser, and then mixed with the volatile substances recovered to the upper part of the condenser.

As described in the step 2 above, the volatilization amount of 1,4-butanediol gradually decreases and the volatilization amount of the low boiling point substances relatively increases with the progress of the polycondensation reaction, thereby lowering the total boiling point of the volatile substances. Accordingly, the difference between the boiling point of the volatile substances and the temperature of the refrigerant is reduced, so that effective condensation in the condenser (200) becomes difficult. As a result, problems such as degradation of the degree of vacuum, and plugging of the entrained oligomer may occur.

Thus, in the present disclosure, 1,4-butanediol fed to the 1,4-butanediol tank (400) is recycled to the volatile substances recovered from the polycondensation reactor (100) in order to increase the content of 1,4-butanediol in the volatile substances fed to the condenser (200). Accordingly, the total boiling point of the volatile substances is increased, and the condensation efficiency can be prevented from being lowered.

When 1,4-butanediol is fed to the condenser (200), it can be appropriately adjusted according to the boiling point of the volatile substances recovered from the polycondensation reactor (100) to the condenser (200). For example, at the beginning of the polycondensation reaction, the volatilization amount of 1,4-butanediol is large, so that the recycling amount of 1,4-butanediol may be reduced. And, it is possible to increase the recycling amount of 1,4-butanediol after the polycondensation reaction proceeds by reaching high vacuum.

According to the preparation method of the present disclosure described above, as the condensation efficiency in the condenser (200) is not lowered, the degree of vacuum of the polycondensation reactor (100) is maintained, thereby increasing the degree of polymerization of polybutylene terephthalate. Also, plugging of the entrained oligomer with the volatile substances of the condenser (200) may be suppressed, and remaining uncompensated gas may be prevented from passing to the vacuum system (500).

### Advantageous Effects

As described above, the preparation method of polybutylene terephthalate according to the present disclosure recycles the recovered 1,4-butanediol, so the condensation efficiency in the condenser is not lowered. Therefore, the degree of vacuum of the polycondensation reactor is maintained, so that the preparation efficiency and the degree of polymerization of polybutylene terephthalate can be increased.

### BRIEF DESCRIPTION OF THE DRAWINGS

FIG. 1 shows a process for preparing polybutylene terephthalate according to Example of the present disclosure.

FIG. 2 shows a process for preparing polybutylene terephthalate according to Comparative Example of the present disclosure.

FIG. 3 shows the results of monitoring the boiling points of the volatile substances recovered to the upper part of the condenser during the polycondensation reaction of polybutylene terephthalate in Examples and Comparative Example of the present disclosure.

### DETAILED DESCRIPTION OF THE EMBODIMENTS

The present invention will be described in more detail with reference to the following Examples. However, the following Examples are for illustrative purposes only, and the present invention is not intended to be limited by the following Examples.

### EXAMPLE 1

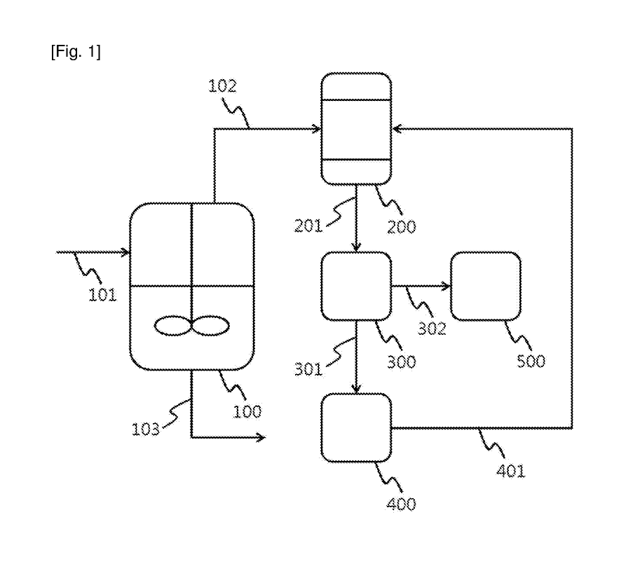

Polybutylene terephthalate was prepared in the same manner as shown in FIG. 1.

First, 194.2 kg of dimethyl terephthalate (DMT), 112.7 kg of 1,4-butanediol (BG) and 0.1 kg of tetrabutyl titanate (TBT) were reacted at atmospheric pressure (1 bar) for 150 minutes while raising the temperature from 140° C. to 190° C. to prepare a polybutylene terephthalate oligomer.

The product was fed into a polycondensation reactor (100), and the temperature was raised from 190° C. to 250° C. for 150 minutes. The pressure was reduced from atmospheric pressure to 20 mbar during the first 50 minutes, and then maintained at 20 mbar. During the reaction, the volatile gas in the upper part of the polycondensation reactor (100) was recovered to a condenser (200), condensed with cooling water (temperature: 40° C.), and fed to a separator (300). Thereafter, 1,4-butanediol was separated from the separator (300), and fed to a 1,4-butanediol tank (400).

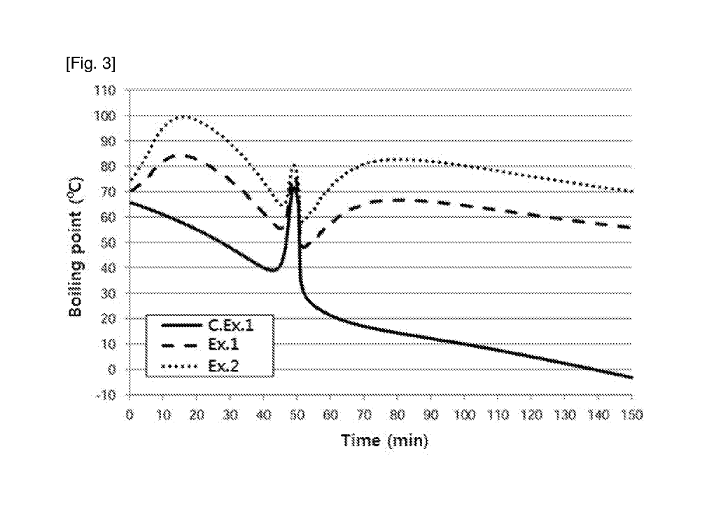

1,4-butanediol was recovered from the 1,4-butanediol tank (400) to the substances recovered in the upper part of the condenser, and a feed rate was adjusted to 0.25 kg/min. During the reaction, the boiling points of the substances recovered to the upper part of the condenser (200) were monitored, and the results are shown in FIG. 3. When the reaction was completed, polybutylene terephthalate prepared in the lower part of the polycondensation reactor (100) was recovered.

### EXAMPLE 2

The experiment was carried out in the same manner as in Example 1, except that 1,4-butanediol was recovered from the 1,4-butanediol tank (400) to the upper part of the condenser with a feed rate of 0.50 kg/min.

### Comparative Example

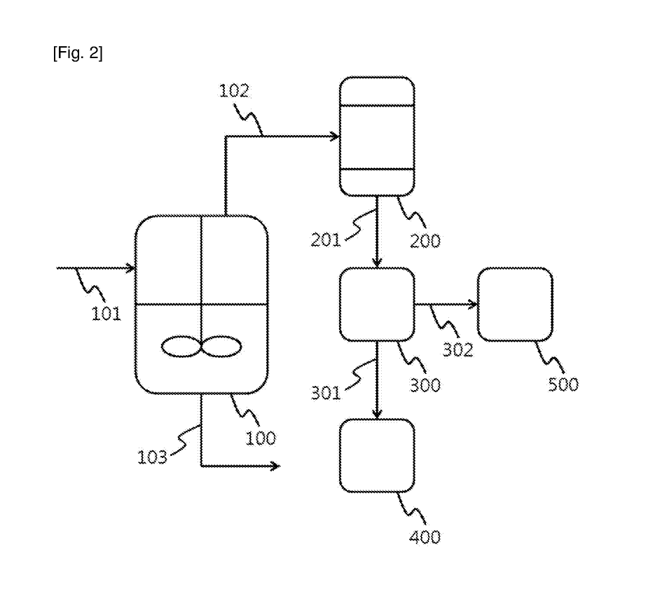

Polybutylene terephthalate was prepared in the same manner as shown in FIG. 2. Polybutylene terephthalate was prepared in the same manner as in Example 1, except that 1,4-butanediol was refluxed from the 1,4-butanediol tank (400) to the upper part of the condenser.

In the above Examples and Comparative Example, the boiling points of the volatile substances recovered to the upper part of the condenser during the polycondensation reaction of polybutylene terephthalate were monitored, and the results are shown in FIG. 3.

First, as shown in FIG. 3, both Examples and Comparative Example exhibited that the boiling point was sharply increased at the point of 50 minutes after the reaction, since the volatilization amount of 1,4-butanediol was increased. This is because the volatilization amount of 1,4-butanediol increased as the polycondensation reaction proceeded at 50 minutes after the reaction when reached high vacuum.

From 50 minutes after the reaction, it was confirmed that the boiling point was gradually decreased in Comparative Example in which 1,4-butanediol was not refluxed. In particular, at about 60 minutes after the reaction, the boiling point was decreased to about 20° C., which is the freezing point of 1,4-butanediol, and this is a major factor in lowering the cooling efficiency of the condenser.

On the other hand, in Example 1, the boiling point was prevented from lowering due to the reflux of 1,4-butanediol, and the boiling point of about 50° C. or more was maintained. In Example 2, the boiling point of about 60° C. or more was maintained by increasing the reflux amount of 1,4-butanediol. Therefore, it was confirmed that, unlike Comparative Example 1, the condensation efficiency of the condenser can be prevented from being lowered.

### DESCRIPTION OF SYMBOLS

100: Polycondensation reactor

200: Condenser

300: Separator

400: 1,4-butanediol tank

500: Vacuum system

101, 102, 103, 201, 301, 302, 401: Lines

1. A method for preparing polybutylene terephthalate, comprising the steps of:
1) feeding a polybutylene terephthalate oligomer prepared by reacting dimethyl terephthalate and 1,4-butanediol in the presence of a transesterification catalyst to a polycondensation reactor;
2) proceeding polycondensation reaction of the polybutylene terephthalate oligomer fed to the polycondensation reactor, and then feeding volatile substances recovered to an upper part of the polycondensation reactor to a condenser, and recovering polybutylene terephthalate to a lower part of the polycondensation reactor;
3) condensing the volatile substances fed to the condenser, and then feeding it to a separator;
4) separating 1,4-butanediol from the condensed volatile substances fed to the separator, and then feeding it to a 1,4-butanediol tank; and
5) feeding 1,4-butanediol fed to the 1,4-butanediol tank to the condenser.

2. The method of claim 1, wherein the transesterification catalyst is used in an amount of 0.1 to 10 mol based on 1000 mol of dimethyl terephthalate.

3. The method of claim 1, wherein in step 1, a molar ratio of the dimethyl terephthalate to the 1,4-butanediol is 1:1 to 1:3.

4. The method of claim 1, wherein the polycondensation reaction in step 2 is carried out at 180° C. to 270° C.

5. The method of claim 1, wherein the polycondensation reaction in step 2 is carried out under a pressure of 1 mbar to 50 mbar.

6. The method of claim 1, wherein the temperature of a refrigerant of the condenser is 20° C. to 40° C.

7. The method of claim 1, wherein in step 5, 1,4-butanediol fed to the 1,4-butanediol tank is fed to the condenser, and mixed with the volatile substances recovered to the upper part of the condenser.
